(19) United States
(12) Patent Application Publication
(10) Pub. No.: US 2017/0257911 A1
(43) Pub. Date: Sep. 7, 2017

(54) ELECTRICAL HEATING DEVICE WITH PTC ELEMENT AND ELECTRICAL SUPPLY LINES AS HEAT CONDUCTOR AND OPERATING FLUID TANK WITH SUCH A HEATING DEVICE

(71) Applicant: Röchling Automotive SE & Co. KG, Mannheim (DE)

(72) Inventors: Fabrizio CHINI, Isera (TN) (IT); Luca MARINI, Besenello (TN) (IT); Ivan DE METRI, Bolzano (BZ) (IT); Francesca BRUNORI, Laives (BZ) (IT); Stefano DALPEZ, Male (TN) (IT)

(73) Assignee: Röchling Automotive SE & Co. KG, Mannheim (DE)

(21) Appl. No.: 15/444,844

(22) Filed: Feb. 28, 2017

(30) Foreign Application Priority Data
Mar. 3, 2016 (DE) 10 2016 203 496.0

(51) Int. Cl. H05B 3/28; F01N 3/20; H05B 3/14

(52) U.S. Cl. CPC H05B 3/286; H05B 3/141; H05B 3/146; F01N 3/2066; H05B 2203/021; H05B 2203/02; F01N 2610/10

(57) ABSTRACT

An electrical heating device (14) for an operating fluid tank (10) of a motor vehicle, in particular for a tank (10) for storing aqueous urea solution, having at least one PTC element (34, 36, 38, 40, 42, 44), that is disposed connecting two electrical conductors (24, 26, 28, 29), characterized in that the electrical heating device (14) comprises a multitude of PTC elements (34, 36, 28, 40, 42, 44), of which each is connectively arranged to two electrical conductors (24, 26, 28, 29), wherein at least one of the electrical conductors (24, 26, 28, 29) is configured as a laminar conductor component and forms a heat conductor for transferring the heat produced in the PTC element (34, 36, 38, 40, 42, 44) to a volume portion of the outside environment (18) of the electrical heating device (14), which is adjacent to the electrical heating device (14).

### CROSS REFERENCE TO RELATED APPLICATION(S)

This application claims priority to German Application No. 10 2016 203 496.0, filed Mar. 3, 2016. The entirety of the disclosure of the above-referenced application is incorporated herein by reference.

### BACKGROUND OF THE INVENTION

Field of the Invention

The present invention relates to an electrical heating device for an operating fluid tank of a motor vehicle, in particular for a tank for storing aqueous urea solution, having at least one PTC element that is disposed connecting two electrical conductors.

The invention furthermore relates to a tank, in particular a motor vehicle operating fluid tank, preferably a tank for storing aqueous urea solution for a selective catalytic reduction, having such an electrical heating device.

Description of the Related Art

An electrical heating device of the above-described type as well as a tank equipped therewith are known from DE 10 2009 028 113 A1.

In the known solution of the above-described type, isolated electrical supply lines pass through the tank wall, more specifically: the tank cover, and make contact with a PTC element, which is the only electrically conducting connection between the two electrical supply lines. A plastic or elastomeric material having a PTC behavior is mentioned as PTC material in the generic publication.

The known heating device of the above-described type serves for heating, in particular for the fluidification or retention of fluidity of an aqueous urea solution in a motor vehicle, in order to be able to carry out with it a selective catalytic reduction in the exhaust gas and thus reduce the nitrogen oxides in the exhaust gas even with cold outside temperatures. This is also the case in the preferred application of the present invention.

Aqueous urea solution freezes at a temperature of −11° C., while the freezing temperature can be lowered to up to −40° C. by additives in the aqueous urea solution. In order to ensure the reduction of nitrogen oxides in the exhaust gas also at low and lowest outside temperatures, it is however necessary to have a constant sufficient supply of fluid reducing agent.

Another electrical heating device, which utilizes PTC elements of ceramic, is known from DE 10 2013 209 957 A1. This publication teaches to connect a PTC element to electrical supply lines by an electrically conducting plastic. The overall arrangement of the PTC element and these electrical supply lines contacted by electrically conducting plastic can be encased in turn in plastic in order to protect it from chemically and/or physically aggressive media in its environment.

PTC elements are components that heat when electric current passes through them and deliver heat to the environment as a result of the temperature gradients resulting from the heating. “PTC” means “Positive Temperature Coefficient,” which indicates that the electrical resistance of the PTC element increases with a rising temperature. This leads to a desired self-limiting of the thermal output of a PTC element. Because the electrical resistance of the PTC element also increases with a rising temperature, the current flow through the PTC element decreases with a rising temperature due to the increasing resistance, so that the amount of heat emitted per time unit by a PTC element becomes increasingly less with a rising temperature of the PTC element. An overheating of the PTC element or the medium heated therewith is prevented in this way.

The chemical stability of the aqueous urea solution that is of interest herein decreases at temperatures higher than 80° C., so that their safe use at high temperatures is highly jeopardized. PTC elements that self-regulate their heat output with a rising temperature are particularly well suited for these reasons for heating aqueous urea solution, but also other operating fluids.

It is disadvantageous of the electrical heating device of the above-described type that it requires either a voluminous or complexly configured PTC element with large surface area to quickly heat a correspondingly large volume area in an operating fluid tank. The heating device may otherwise possibly only be able to selectively input heat for a short time into a tank, which may not be sufficient under certain conditions to quickly achieve the desired degree of reduction in the exhaust after a cold start.

### SUMMARY OF THE INVENTION

It is therefore an object of the present invention to improve the electrical heating device of the above-described type to the effect that it can transfer the largest possible amount of heat to its environment within the shortest possible time.

This object of the present invention is achieved with a generic heating device in that the electrical heating device comprises a multitude of PTC elements, each of which is disposed connecting to two electric conductors, wherein at least one of the two electrical conductors is configured as a laminar conductor component and forms a heat conductor for transferring heat produced in the PTC element to a volume portion of the outside environment of the electrical heating device, which is adjacent to the electrical heating device.

In the electrical heating device of the present invention, the heat conducting surface of the heating device is enlarged by using the electrical conductors as heat conductors, which must unavoidably be connected to the PTC element to supply the PTC elements with electric current or in order to conduct electric current through it. At least one electrical conductor is configured for this purpose as a laminar conductor component. This means that its dimension in the thickness direction is the smallest dimension of the conductor component and that its dimensions are considerably greater in each of the two remaining spatial directions with respect to each other as well as the thickness direction, that is, they amount to more than 5 times, preferably more than 10 times, particularly preferably more than 20 times the thickness dimension.

Since the laminar electrical conductor is not necessarily configured flat, the local spatial directions, for example, if the thickness direction dependent from the location on the electrical conductor is oriented differently, are important with regard to the mentioned dimensions in the mentioned spatial directions.

One of the two electrical conductors with relatively large surface contacted by the PTC element can thus at least be used as a heat conducting element for transfer of heat emitted by the PTC element. As a heat conductor, the electrical conductor can then transfer the heat produced during the energization of the PTC element to a volume portion of the outside environment of the electrical heating device, which is adjacent to the electrical heating device, and thus heat a medium contained in this volume portion.

A plurality of heat sources, whose generated heat can be respectively transferred via at least one the heat conductor formed by the electrical conductors contacted by the respective PTC elements via the at least one of the respective PTC elements, can be provided in the heating device as a result of the use of a plurality of PTC elements, which are preferably disposed at a distance from each other. Even an electrical conductor with a large surface can be utilized as heat conductor over its entire surface.

Both electrical conductors, which are contacted by a PTC element, can be advantageously configured as laminar conductor components, so that each of these electrical conductors contacted by a PTC element forms a heat conductor in order to further enlarge the heat conducting surface of the heating device according to the invention.

Some or all PTC elements can be made from PTC ceramic. Some or all PTC elements can likewise be made from PTC plastic, wherein the PTC plastic can be realized as a rule by a thermoplastic material filled with corresponding filler material, which can be brought, for example, by injection molding, into almost any desired shape.

It is preferable if a plurality of PTC elements are arranged parallel between the same two electrical conductors, since in this way the number of electrical conductors for supply of the PTC elements can be kept low, and since in this way the surface of the PTC elements can additionally be kept small, and since as a result the surface of the electrical conductor can also be utilized as a heat conducting surface in its entirety as evenly as possible, which leads to a very efficient use of the electrical conductor as a heat conductor. The PTC elements arranged in parallel are here to be understood as connected electrically in parallel. They need not necessarily, but can, however, be aligned spatially parallel to each other or run along a straight line. The two electrical conductors, between which the PTC elements are arranged connected in parallel, can actually have irregular shapes, for instance with locally different widths, so that no specification about their spatial arrangement or about the shape of one or both electrical conductors is to be made as a result of the electrical parallel arrangement of PTC elements.

A multitude of PTC elements can additionally or alternatively be arranged connected in series between respectively different electrical conductor pairs. Here is meant also an electrical series arrangement (series connection) and not necessarily a spatial series arrangement.

A separate electrical conductor, which connects these PTC elements electrically to each other, is necessary between each two PTC elements respectively connected in series in the series connection of PTC elements, which increases the number of required electrical conductors. The number of heat conductors is however also thereby increased, while complex tank geometries, especially tank wall geometries, including the tank bottom, can also be heated over their entire surface with local bottlenecks and the like as a result of an electrical series arrangement of PTC elements.

It is therefore rather preferable to heat large uniform surface areas with PTC elements connected in parallel with less electrical conductors and smaller and more complexly configured surface areas with considerably greater length than width, and if required with a course with one or even several curves connected in series by PTC elements.

Motor vehicle operating fluid tanks, whose preferred use is the heating device described here, are adapted, as a rule, even to strict installation space specifications in the interior of the motor vehicle, wherein surface geometries of the tank walls, especially of the tank bottom, which deviate from the standard shapes also arise here. The surface can then be supplied well and effectively with heat if two electrical conductors have a different shape. A large part of a tank volume portion can thus be supplied with heat either directly by PTC elements or indirectly with electrical conductors heated by PTC elements.

The electrical conductors can be arranged side by side, while the multitude of PTC elements bridge the gap between two electrical conductors resting side by side. The electrical conductors then face each other with their mutually approximated edge areas. A thinnest possible heating device with largest possible heat emitting surface is thus achieved.

The electrical conductors can additionally or alternatively be arranged one on top of the other. The multitude of PTC elements can then bridge the gap between two mutually opposite surfaces of electrical conductors. At least one isolator component can additionally be arranged as spacer between the mutually opposite surfaces in order to prevent a short circuit of the two superimposed electrical conductors. This is advantageous above all when the two electrical conductors extend over a considerably larger surface than the PTC elements provided between them, so that a direct touching contact of the conductors due to the deformation of one or both conductors is to be feared.

The electrical conductors can be configured as a metal foil or a generally conducting foil with a thickness of a few micrometers, for instance, 8 μm and more, up to a thickness of a few millimeters, so that it can also be conceived to produce, for example, by cutting or punching, one or several electrical conductors from one metal sheet.

It can also be conceived to produce the electrical conductors from electrically conducting plastic, for example, using a thermoplastic composite material with a thermoplastic material matrix, in which electrically conductive particles are embedded. The particles can have any desired suitable shape, such as, for instance, a spherical shape or fiber shape, or also an irregular particle shape, such as those produced, for example, during the hardening of atomized spray of electrically conducting material. Filings of electrically conducting metal are also conceivable as particles for embedding in an electrically conducting plastic.

A touch contact is sufficient for the contacting of a PTC element with an electrical conductor allocated thereto. It can therefore be conceived that at least one PTC element is connected to an electrical conductor by adhering with an electrically conducting adhesive and/or by soldering, in particular hard soldering, and/or by using special fasteners, such as, for instance, rivets and/or screws, in particular fasteners of plastic. Adhesive or soldered connections have a very high strength in comparison to the other connections with additional fasteners, while contaminants are prevented at the same time from penetrating into the contact gap between the PTC element and the electrical conductor and thus reducing the contact quality.

It is preferable that the fasteners, such as, for instance, rivets or screws, are themselves not electrically conducting.

As protection against chemical or physical decomposition, for example, due to the medium to be heated, the electrical heating device can be covered with a foil or overmolded with plastic at least on one side. It can also be introduced between two foils, in particular welded, which cover on both sides and circumferentially fully encase the electrical heating device.

It can be accommodated on a substrate on one side, wherein the side that faces toward the substrate is the side of the heating device or the electrical conductor that faces away from the foil if the heating device is covered with a foil only on one side.

The substrate is preferably a rigid substrate for the purpose of preventing undesirable deformations of the heating device during operation, for instance as a result of vibrations immanent to the operation of a motor vehicle during driving. This applies above all if the electrical conductors are not inherently stable, for instance because they are configured as a metal foil. If the electrical conductors are inherently stable due to their shape or thickness, then the substrate can be non-rigid or even be entirely omitted.

The at least one electrical conductor, which is connected to a PTC element of the previously described heating device, need not necessarily also function as power supply for the PTC element, but this is advantageous to ensure the lowest possible number of components.

The initially mentioned object is also achieved by a tank, in particular a motor vehicle operating fluid tank, preferably a tank for storing aqueous urea solution, with an electrical heating device as described and further developed above.

For the best possible heat transfer into the medium that is to be heated and is held in the tank, the electrical heating device is arranged in such a way in the tank interior that a heat transfer surface of the heating device is located at a distance from the tank inner wall surface.

In order to also utilize the surface opposite to the main heat transfer surface of the heating device—if also possibly only to a limited extent—the electrical heating device is preferably arranged forming a gap space between it and a tank interior wall surface. The medium that is held in the tank and is to be heated can preferably flow through the gap space.

### BRIEF DESCRIPTION OF THE DRAWING FIGURES

The present invention will be described in more detail in the following with the aid of the accompanying drawings.

FIG. 1 shows a roughly schematic longitudinal sectional view through a lower case of a motor vehicle operating fluid tank according to the invention having a first embodiment of an electrical heating device according to the invention accommodated therein; and

FIG. 2 shows a roughly schematic transversal sectional view through a second embodiment of an electrical heating device according to the invention.

### DETAILED DESCRIPTION OF THE PREFERRED EMBODIMENTS

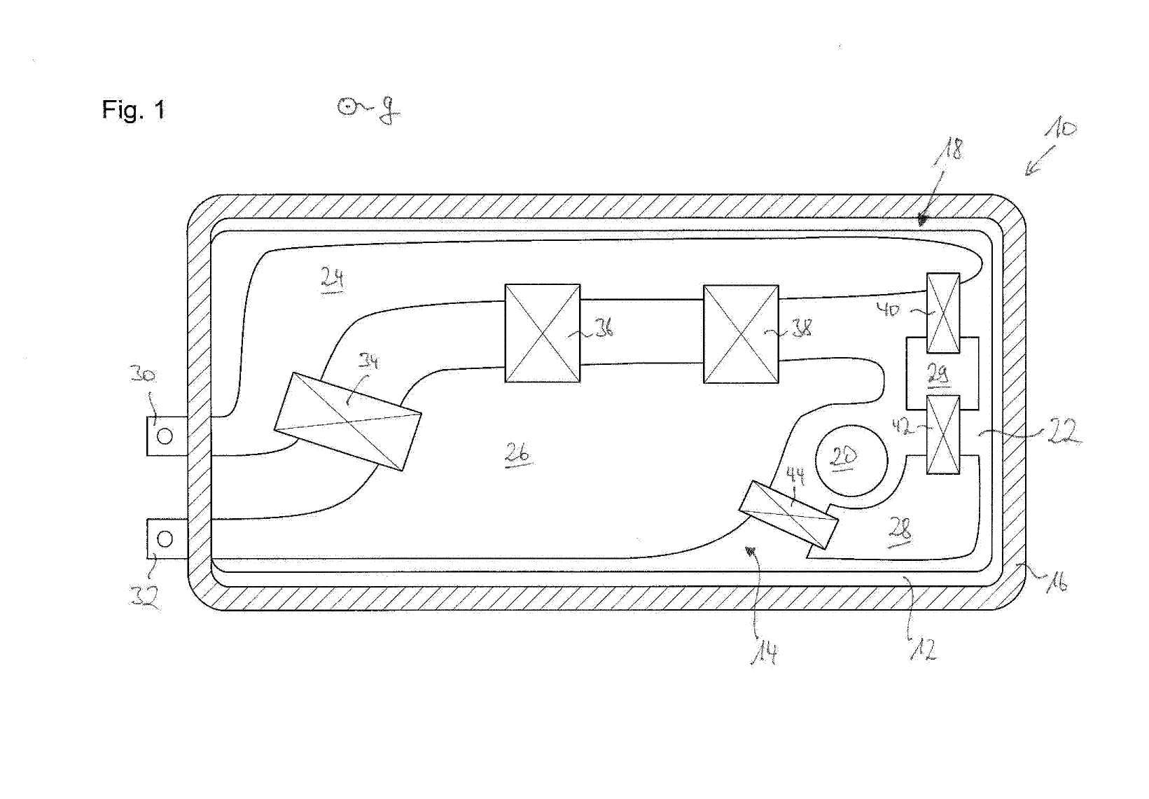

In the single FIG. 1, a motor vehicle operating fluid tank is identified overall with reference numeral 10. The tank 10 is shown in longitudinal section in a section plane parallel to the bottom. In the finalized operationally ready state arranged in the motor vehicle, the direction of effect of the force of gravity g runs orthogonally to the section plane and orthogonally to the drawing plane of FIG. 1. The section plane passes through a lower case of the tank 10. The observer of FIG. 1 looks thus in the direction of a tank bottom 12, beyond which, that is, in the direction of the observer of FIG. 1, an electrical heating device according to the invention identified overall with reference numeral 14 is arranged.

The lateral wall 16, which is intersected by the section plane and extends fundamentally orthogonally to the drawing plane, is represented shaded in FIG. 1.

It is expressly pointed out that FIG. 1 merely shows a roughly schematic representation of a motor vehicle operating fluid tank 10 according to the invention and the heating device 14 accommodated therein.

In the interior 18 of the tank 10 is stored an operating fluid for selected extraction therefrom. An aqueous urea solution is preferably conceived thereby as reducing agent in a selective catalytic reduction of the exhaust gas of the motor vehicle. The operating fluid stored in the tank interior 18 can be extracted through an extraction opening 20 in the bottom 12 of the tank by a feed pump, if required supported by a valve for dosing, and fed, for example, to an injection nozzle in the exhaust gas system.

The heating device 14 is provided in the tank interior 18 in order to prevent the operating fluid from freezing or in order to keep it fluid in said tank interior.

The heating device 14 has a substrate 22, which is arranged at a distance from the tank bottom 12 and approximately parallel thereto. In the present case, the substrate 22 is formed by a flat rigid plastic plate, whose main plane of extension runs parallel to the drawing plane of FIG. 1. The substrate 22 has an opening above the extraction opening 20 to ensure the unimpeded flow of operating fluid from the tank interior 18 through the extraction opening 20.

Electrical conductors 24, 26, 28 and 29 are provided on the fundamentally flat substrate 22 on the side facing away from the tank bottom 12. The number of electrical connectors can be more or less than the mentioned four conductors. The electrical conductors 24, 26, 28 and 29 are arranged side by side in the embodiment shown in FIG. 1. They extend in the same main extension surface.

The ends of the electrical conductors 24 and 26 are guided through the tank wall 16 as contacts 30 and 32 in order to be available on the outside of the tank 10 for contact with an electric current supply.

The electrical conductors 24 and 26 consequently comprise the main power supply of the electrical heating device 14, since the latter can be directly connected to an electric current source via its contacts 30 and 32. Three—but there also can be more or less—PTC elements 34, 36 and 38, which are provided in the parallel connection between the electrical conductors 24 and 26, are arranged between the electrical conductors 24 and 26 in the example shown.

The electrical conductors 24 and 26 are shaped as a laminar structure in order to conduct, as heat conductors, the heat produced as a result of the current flow in the PTC elements 34, 36 and 38 into the surface of the heating device 14 and transfer it from there over a large surface to the tank interior 18 and the reducing agent contained therein.

Further PTC elements 40, 42 and 44 are overall connected in parallel to the first-mentioned PTC elements 34, 36 and 38, but are electrically connected in series to each other, wherein the electrical conductor 29 is arranged between the PTC elements 40 and 42, and the electrical conductor 29 is arranged between the PTC elements 42 and 44. Both electrical conductors 28 and 29 are configured in turn as laminar conductors, that is, their material thickness is considerably smaller than their measurement in the direction of the length and/or width, wherein the largest occurring width of an electrical conductor is at least 30 times greater than the thickness of the electrical conductor in the shown embodiment. The direction of the thickness of the flat electrical conductors 24, 26, 28 and 29 runs orthogonally to the drawing plane of FIG. 1. The thickness of the electrical conductors 24, 26, 28 and 29 is fundamentally spatially constant. The PTC elements 34, 36, 38, 40, 42 and 44 are preferably adhesively connected by an electrically conducting adhesive to their respectively contacted electrical conductors.

The PTC elements of the heating device 14 can be identical, but do not have to be. The PTC elements, which are electrically connected in series to each other, differ from the PTC elements that are connected in parallel to each other. However, the PTC elements that are connected in parallel to each other also do not have to be identical.

The PTC elements 34, 36, 38, 40, 42 and 44 are the selectively hottest spots of the heating device 14 when the contacts 30 and 32 are fed with current in the heating device 14 represented in FIG. 1, wherein the heat produced therein is dissipated via the laminar electrical conductors 24, 26, 28 and 29 and is delivered over the greatest possible surface into the operating fluid held in the tank interior 18.

The heating device 14 can be covered to the observer with a foil or can be overmolded with plastic, so that the electrical conductors and the PTC elements cannot be chemically attacked by the operating fluid.

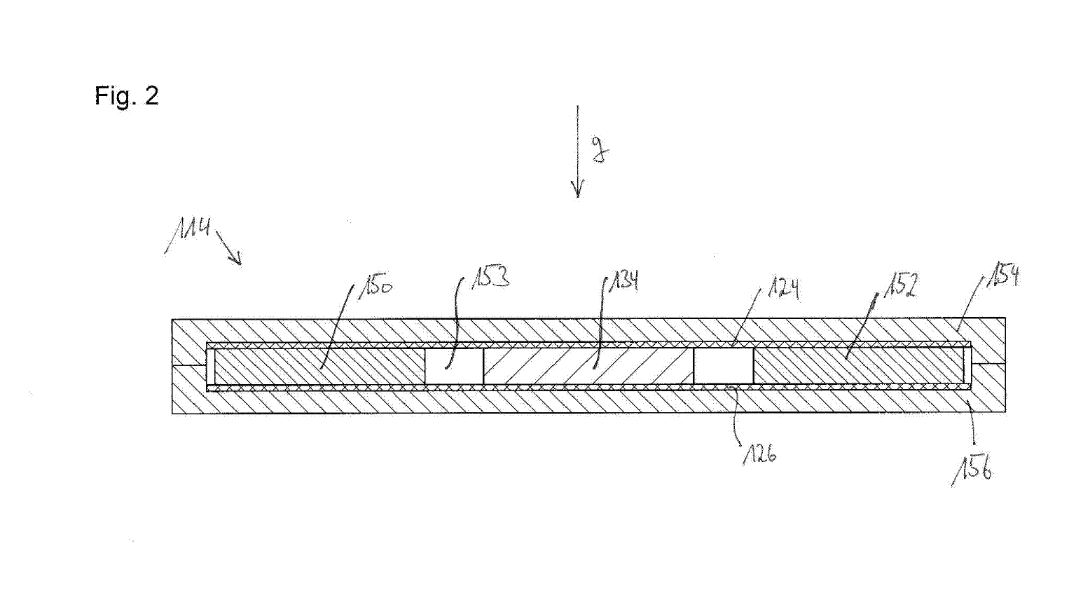

In FIG. 2 is represented roughly schematically in section in a second embodiment of the invention, a heating device 114 according to the invention. Components and component portions that are identical and have the same function are identified with the same reference numerals as in the first embodiment, but increased by the number 100. The second embodiment will be described in the following only with regard to its differences with respect to the first embodiment of FIG. 1, to whose description reference is expressly made, and also to describe the second embodiment shown in FIG. 2.

The electrical conductors 124 and 126 are not arranged side by side, as in the first embodiment, but one on top of the other, in the second embodiment of FIG. 2, so that the electrical conductors 124 and 126 preferably extend in preferably mutually parallel but mutually spaced main extension surfaces.

The electrical conductors 124 and 126 are connected to each other by a PTC element 134, whose extension surface is considerably smaller than that of the electrical conductors 124 and 126. Spacers 150 and 152 of insulating material, for example, of electrically insulating plastic, are consequently arranged to prevent an undesirable short circuit of the electrical conductors 124 and 126 at those locations of the spacing gap 153 between the electrical conductors 124 and 126 that are at such a distance to the side of the PTC element 134 that a short circuit is to be feared or basically cannot be ruled out as a result of a deformation of the electrical conductors 124 and 126 with respect to each other. The spacers 150 and 152 are preferably configured with the same thickness as the PTC element 134.

The assembly of electrical conductors 124 and 126 with the intermediately arranged components: PTC element 134 and spacers 150 and 152, is accommodated between two plastic foils 154 and 156, which protect the assembly from environmental influences, for example, from a chemical attack of an aqueous urea solution surrounding the heating device 114.

The electrical conductors 124 and 126 arranged one on top of the other can be individually adjacent to further electrical conductors in side by side arrangement or can be adjacent to another assembly of electrical conductors arranged one on top of the other with PTC elements arranged between them in side by side arrangement.

1. An electrical heating device for an operating fluid tank of a motor vehicle, comprising:
a plurality of PTC elements, each of which is connectively arranged to two electrical conductors;
wherein at least one of the electrical conductors is configured as a laminar conductor component and forms a heat conductor for transferring heat produced in the PTC element to a volume portion of the outside environment of the electrical heating device, which is adjacent to the electrical heating device.

2. The electrical heating device according to claim 1,
wherein both electrical conductors that contact one PTC element are configured as laminar conductor components, each forming one heat conductor.

3. The electrical heating device according to claim 1,
wherein the PTC elements are made from PTC ceramic and/or PTC plastic.

4. The electrical heating device according to claim 1,
wherein a plurality of PTC elements are arranged in parallel between the same two electrical conductors.

5. The electrical heating device according to claim 1,
wherein a plurality of PTC elements are arranged in series between respectively different electrical conductor pairs.

6. The electrical heating device according to claim 1,
wherein two electrical conductors have a different shape.

7. The electrical heating device according to claim 1,
wherein the PTC elements are thicker than the electrical conductors, which they connect.

8. The electrical heating device according to claim 1,
wherein at least one PTC element is connected to an electrical conductor by adhering with an electrically conducting adhesive and/or by soldering, and/or by using fasteners.

9. The electrical heating device according to claim 1,
wherein it is covered with a foil or over molded with plastic at least on one side or/and is covered with a foil or over molded with plastic on both sides and/or is accommodated with one side on a substrate.

10. A motor vehicle operating fluid tank, having an electrical heating device according to claim 1,
wherein the electrical heating device is preferably arranged in such a way in the tank interior while forming a gap space between it and a tank interior wall surface that a heat transfer surface of the heating device is located at a distance from the tank inner wall surface.

11. The electrical heating device according to claim 1,
wherein at least one PTC element is connected to an electrical conductor by hard soldering.

12. The electrical heating device according to claim 1,
wherein at least one PTC element is connected to an electrical conductor by using rivets and/or screws.

13. The electrical heating device according to claim 1,
wherein at least one PTC element is connected to an electrical conductor by using plastic fasteners.

14. The electrical heating device according to claim 1,
wherein said electrical heating device is covered with a foil or over molded with plastic at least on one side or/and is covered with a foil or over molded with plastic on both sides and/or is accommodated with one side on a rigid substrate.

15. The motor vehicle operating fluid tank according to claim 10, wherein said tank is for storing aqueous urea solution.
